(19) United States
(12) Patent Application Publication
(10) Pub. No.: US 2016/0341638 A1
(43) Pub. Date: Nov. 24, 2016

(54) AUTOMATED SLIDE STAINER

(71) Applicant: ALPHA-TEC SYSTEMS, INC., Vancouver, WA (US)

(72) Inventors: Richard O. Williams, Vancouver, WA (US); Mark Williams, Vancouver, WA (US); John Kempke, Vancouver, WA (US)

(21) Appl. No.: 14/964,308

(22) Filed: Dec. 9, 2015

Related U.S. Application Data
(60) Provisional application No. 62/164,450, filed on May 20, 2015.

(51) Int. Cl. G01N 1/31; B05C 13/02; G01N 35/00; G01N 35/02; G01N 35/10; B05C 5/02; G01N 1/30

(52) U.S. Cl. CPC G01N 1/312; B05C 5/0208; B05C 5/0225; B05C 13/02; G01N 1/30; G01N 35/025; G01N 35/1002; G01N 35/00029; G01N 35/1011; G01N 35/1081; G01N 2035/00138

(57) ABSTRACT

The present disclosure describes an automated slide stainer with a rotary carousel configured to receive a plurality of microscopic slides. The rotary carousel may position the slides in a treatment position to receive a liquid reagent on the slide surface from a dispensing nozzle. The reagent discharge may be drained off from the slide surface by rotation of the rotary carousel, by inclining the slide, and/or by directing an air stream to the slide surface

### FIELD OF INVENTION

The present description relates to an automated slide stainer.

### BACKGROUND

Automated slide stainers may be used to stain biological samples mounted on microscopic slides for visualizing histological, histochemical and immunohistochemical constituents of the samples. Staining of the biological samples mounted on a microscopic slide may include addition and removal of multiple reagents in a defined sequence for a specified amount of time. Additionally, the residues of a first reagent may need to be removed from the slide before addition of a second reagent, requiring washing of the slide with a wash reagent and draining of reagents from the slide surface. In some procedures, the slides may need to be air dried after a reagent is removed from the slide surface.

The reagents for staining a slide may be dispensed as an aerosol spray on the slide surface with the sample or the slides may be dipped in a staining reagent by an automated slide stainer. However, aerosol spray nozzles may not deposit the reagent uniformly across the slide surface. Additionally, the spray nozzles may be prone to blockage, resulting in inconsistent spray atomization. Dipping multiple slides into a staining reagent in a liquid reservoir may result in uniform staining but may increase the possibility of cross-contamination.

To mitigate the problem of non-uniform reagent distribution on the slide surface during staining, and to minimize cross-contamination due to multiple slides dipping into the same reagent, the inventors propose an automated slide stainer, including a rotary carousel with a plurality of slide trays, each slide tray configured to receive a microscopic slide in a horizontal orientation, a positioning device to move each slide tray to a treatment position, and at least one dispensing nozzle to dispense a liquid reagent on the microscopic slide when in treatment position. In one example, the positioning device of the automated stainer may be a motor coupled to the rotary carousal sequentially positioning each slide tray of the rotary carousel in the treatment position. In one embodiment of the automated slide stainer, a plurality of dispensing nozzles and a rotary carousal may be housed inside a catch basin with a drain connection. The dispensing nozzles may be connected to a reagent reservoir system, including a valve and a pump, regulating the flow of liquid reagent from the dispensing nozzle.

The rotary carousel of the automated stainer may include at least one slide drain opening in each of the slide trays. The rotary carousel may further include a slide securing mechanism and cutouts on each of the slide trays for gripping the slides without touching the slide top and bottom surfaces. Rotation of the rotary carousel may drain the reagent from the slide surface through centrifugal force. The slide trays of the rotary carousel may be inclined to drain off reagent discharge from a top surface of a slide mounted on the slide tray. In one embodiment, a stream of compressed air may be directed at the slide on the slide tray to remove reagent discharge from the slide surface.

One example of using the above described automated slide stainer may include receiving a microscopic slide in a rotary carousel in a horizontal orientation, positioning the microscopic slide in a treatment position for receiving a liquid reagent, dispensing the liquid reagent to the slide surface through a dispensing nozzle, and removing the liquid reagent discharge from the slide surface. In one example, positioning of the microscopic slide on the rotary carousel in the treatment position may be done by a motor coupled to the rotary carousel. The dispensing nozzle may discharge the liquid reagent from a reagent reservoir, regulating reagent flow through a valve and a pump. In one example, removing the liquid reagent discharge from the slide surface may be by rotation of the rotary carousel. In another example, the liquid reagent discharge may be removed from the slide surface by inclining the slide tray of the rotary carousel. In a further example, the liquid reagent discharge may be removed from the slide surface by blowing compressed air through a laminar airflow system.

Thus, the automated slide stainer described above enables uniform staining of slides without cross-contamination of reagents between the slides. The rotary carousel of the automated slide stainer precisely positions each of the slides in receiving proximity of a liquid reagent from a dispensing nozzle. The slide surface with the biological sample in a horizontal orientation receives the liquid reagent on the slide surface. The automated slide stainer may also remove the reagent discharged on the slide surface, thereby making the automated stainer conducive for various staining protocols for biological samples mounted on a slide.

### BRIEF DESCRIPTION OF THE DRAWINGS

FIG. 1 shows a perspective view of an automated slide stainer including a rotary carousel, a catch basin, and dispensing nozzles.

FIG. 2 shows a cross-sectional view of the automated slide stainer of FIG. 1.

FIG. 3 shows a top view of a slide tray attached to a rotary carousel.

FIG. 4 illustrates a dispensing nozzle and a slide tray of the automated stainer of FIG. 1.

FIG. 5 shows a view of an inclined slide tray of the automated stainer of FIG. 1.

FIG. 6 shows a schematic of a reagent delivery system supplying reagent to a dispensing nozzle.

FIG. 7 illustrates an embodiment of an automated slide stainer with a laminar airflow tube.

FIG. 8 shows the orientation of the laminar airflow tube of FIG. 7 relative to a slide surface on a rotary carousel slide tray.

FIG. 9 illustrates a schematic of the laminar air blast system for delivering compressed air to a laminar airflow tube.

FIG. 10 illustrates an embodiment of an automated slide stainer with a hinged lid.

FIG. 11 illustrates an example method using the automated slide stainer of FIG. 1 for a staining procedure.

### DETAILED DESCRIPTION

The present application relates to an automated slide stainer. The automated stainer may include a rotary carousel with a plurality of slide trays, each slide tray receiving and securing a standard microscopic slide in a horizontal orientation. The rotary carousel may be housed inside a catch basin with at least one reagent-dispensing nozzle. The rotary carousel may sequentially move each of the slide trays to position the slide trays with the slide in a treatment position to receive a liquid reagent from the dispensing nozzle on a top surface of the slide with a sample. The dispensing nozzle housed inside the catch basin may deliver the stream of liquid reagent from a connected reagent reservoir. The liquid reagent flow from the reservoir to the dispensing nozzle may be driven by a pump and the reagent flow through the dispensing nozzle may be regulated by a valve. The reagent discharge may be removed from the slide surface by generating centrifugal force through rotation of the rotary carousel with the slide trays along a rotation axis, driven by an electric motor coupled to the rotary carousel. The reagent may be drained from the slide surface by inclining the slide tray holding the slide. A laminar airflow system may also be used to remove excess reagent from the slide surface. The reagent run off in the catch basin may be drained through a drain connection in the catch basin.

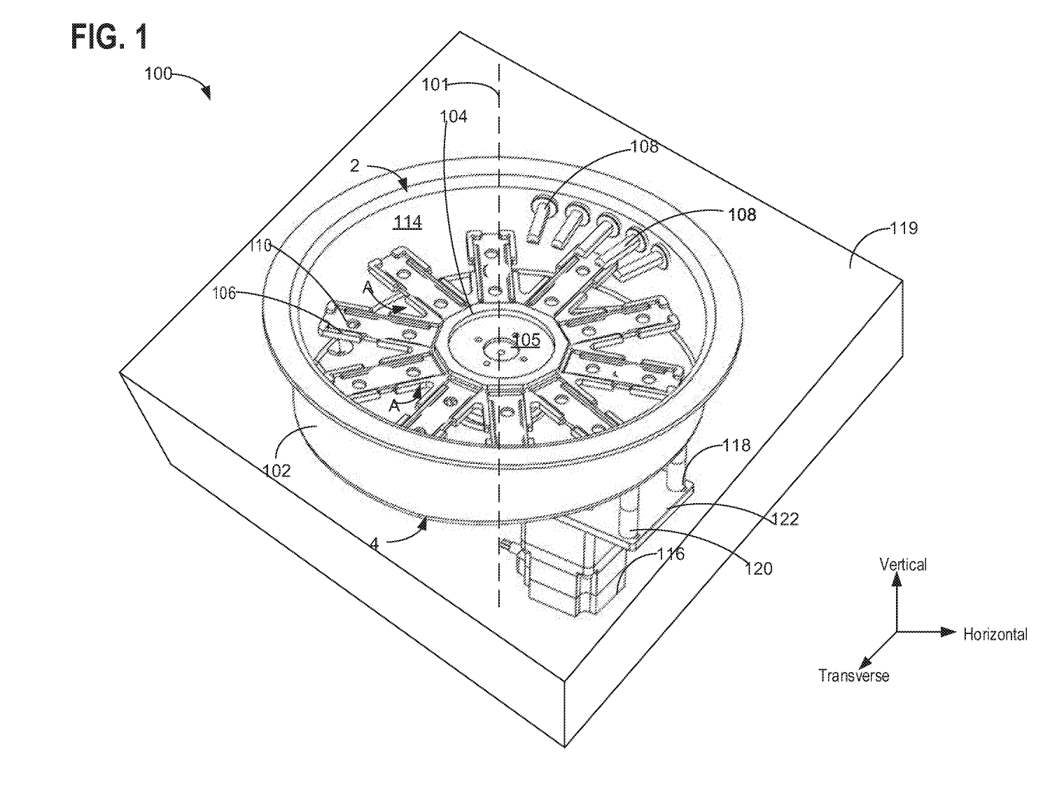

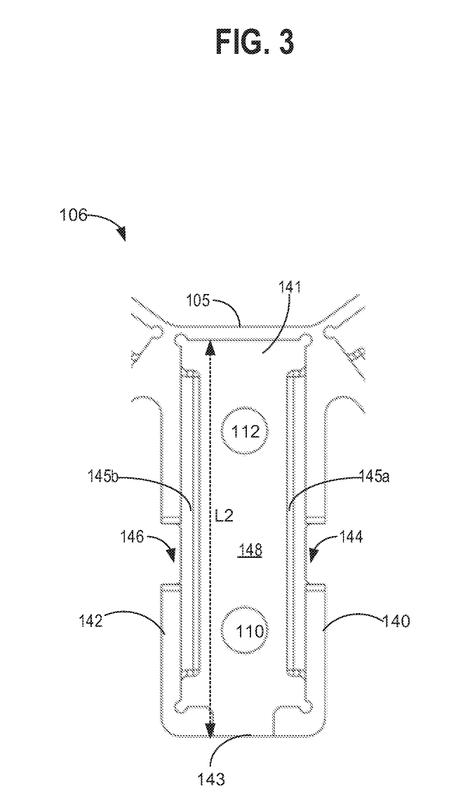

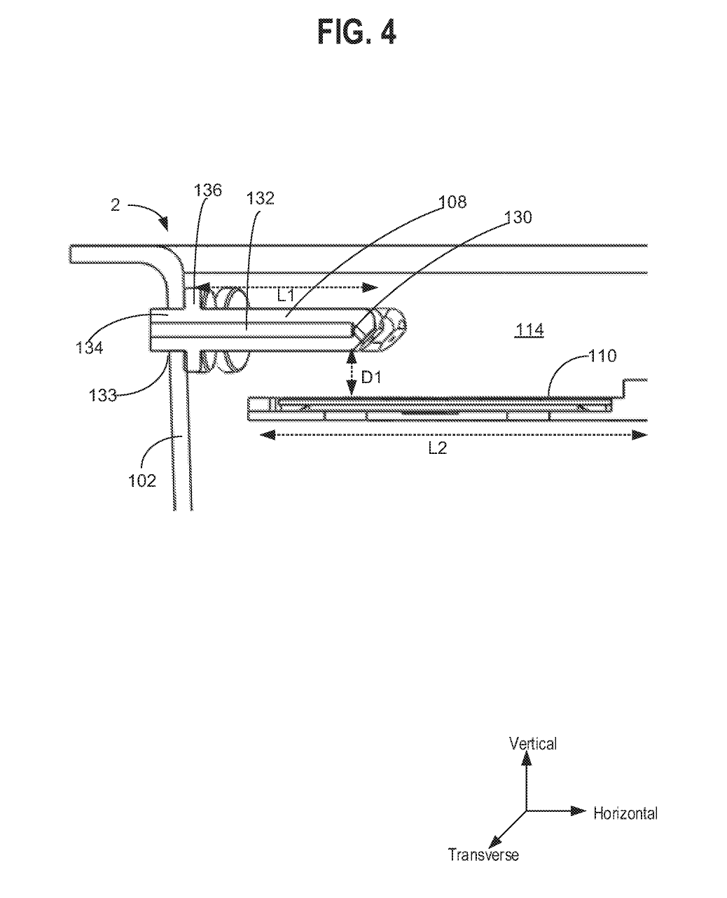

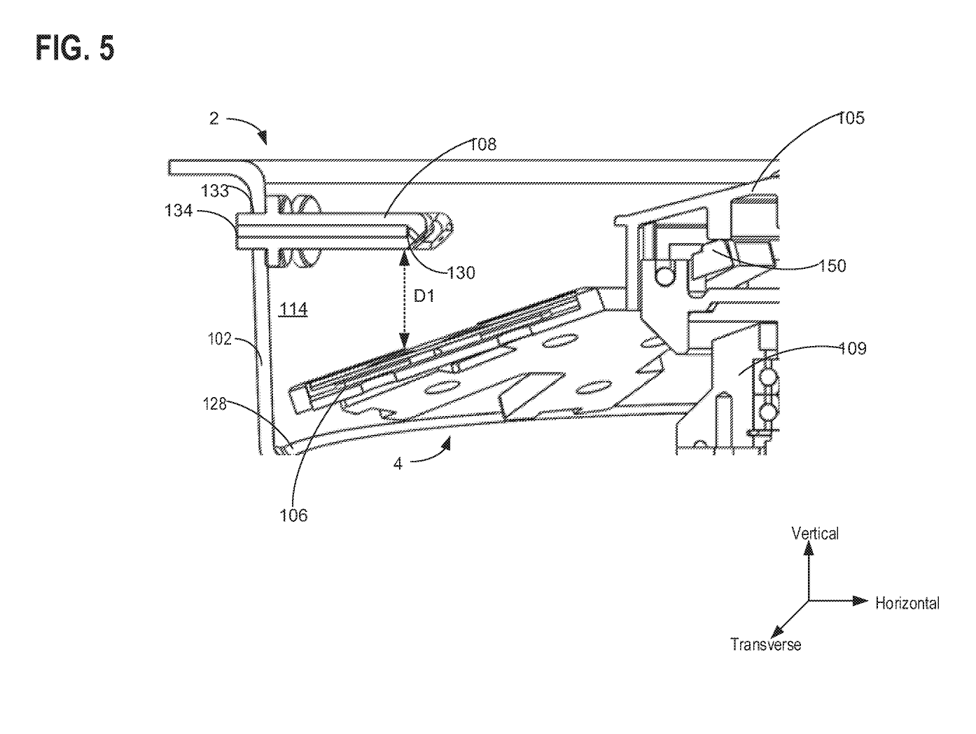

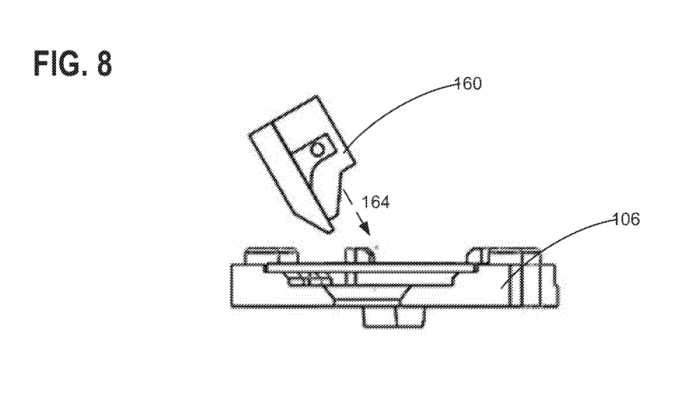

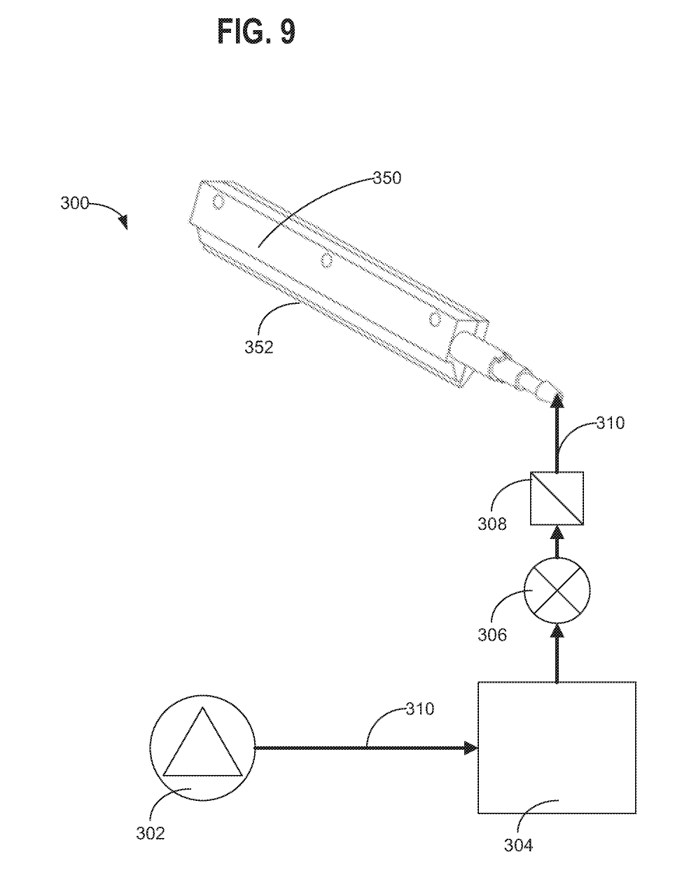

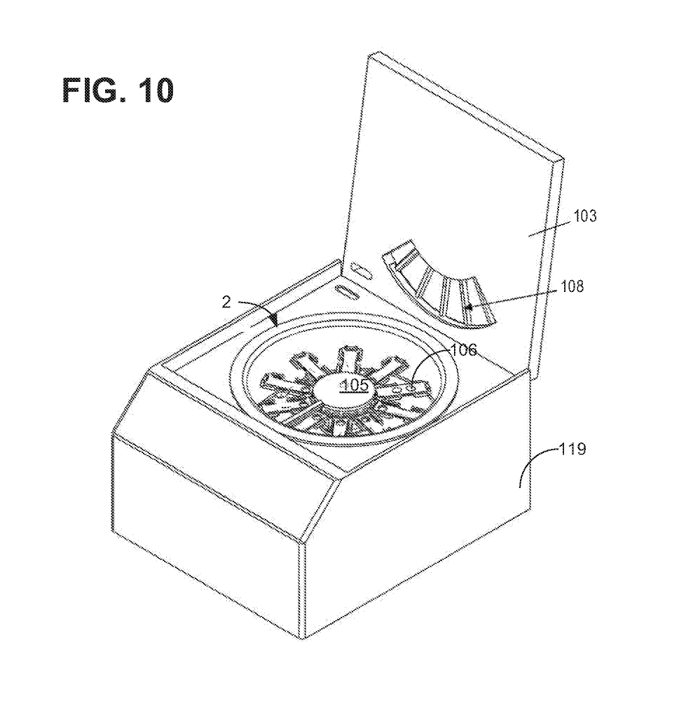

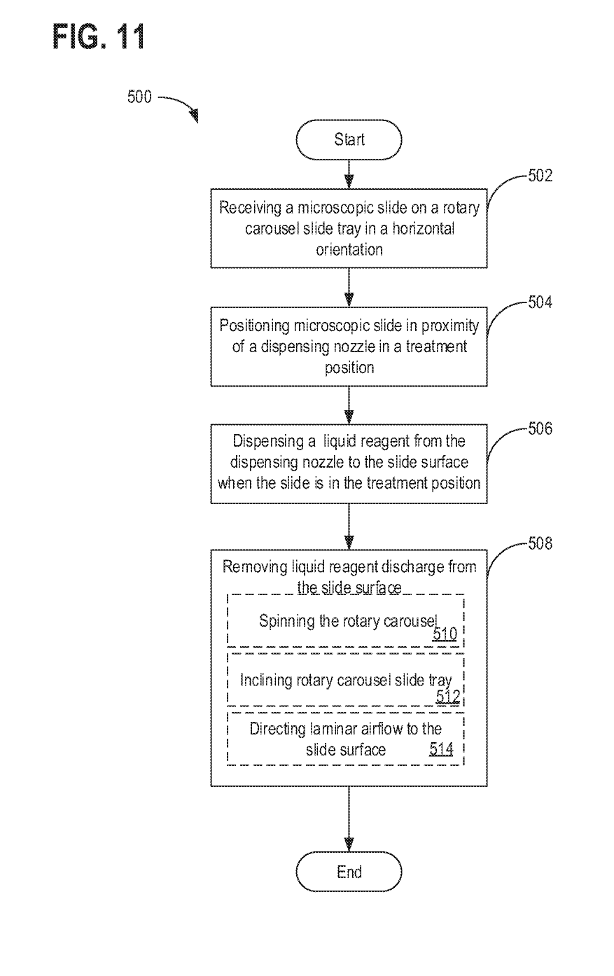

FIGS. 1-3 show an embodiment of an automated slide stainer 100 including a catch basin with a drain connection, housing a plurality of dispensing nozzles and a rotary carousel with a plurality of slide trays, each slide tray may receive one standard microscopic slide in a horizontal orientation. The slide tray may include a slide securing mechanism and a reagent draining mechanism, including inclining the slide tray to drain off reagents from the slide surface, as shown in FIGS. 3 and 5. The dispensing nozzles may be housed inside the catch basin and may be connected to a liquid reagent reservoir system, as illustrated in FIGS. 4-6. In one embodiment of the automated stainer, a laminar airflow system may assist in removing the reagent from the slide surface and in air-drying of the slides mounted on the rotary carousel slide trays, as illustrated in FIGS. 8 and 9. FIG. 10 illustrates an embodiment of an automated slide stainer with a hinged lid. The embodiments illustrated in FIGS. 1-5 and FIGS. 7, 8, and 10 are drawn approximately to scale, although various modifications in the relative sizing of one or more components may be made. FIG. 11 shows an example method for staining sample on a slide surface, using the automated slide stainer of FIG. 1. For purpose of discussion, FIGS. 1-9 will be described collectively.

In one non-limiting example, an automated slide stainer 100 may include a catch basin 102 housing a rotary carousel 104 with a plurality of slide trays 106 (for example, ten slide trays) and a plurality of dispensing nozzles 108 (for example, five dispensing nozzles), as illustrated in FIG. 1. The automated slide stainer 100 may have a center axis 101. Vertical, horizontal, and transverse axes for the automated slide stainer 100 are also depicted. The vertical axis may be parallel to the center axis 101 and the horizontal axis may be perpendicular to the center axis 101. The catch basin 102 may be substantially circular with a top open end 2 and a bottom end 4 opposite the top open end 2. In one example, the top open end 2 may be configured to couple to a hinged removable lid 103 that may enclose the catch basin, as illustrated in FIG. 10.

Referring to FIG. 1, the catch basin 102 may be attached to a motor mount plate 122 through anchoring pillars 118 and 120. The motor mount plate 122 may be parallel to the catch basin bottom end 4 and may function as a stable flat base for mounting the drive mechanism. The anchoring pillars 118 and 120 may be in face sharing contact with the catch basin bottom end 4 on a first end and on the opposite end, the anchoring pillars may be in face sharing contact with the mount plate 122. In one embodiment, the anchoring pillars 118 and 120 may be welded to the stationary platform 122 and to the catch basin bottom end 4. In another example, a single anchoring pillar may attach the catch basin 102 to the mount plate 122. In a further example, four anchoring pillars may attach the catch basin 102 to the mount plate 122. The catch basin and mounting plate assembly may be mounted within a larger cabinet 119 via the top rim of the catch basin. The assembly may also be mounted to the cabinet via an extension of the motor mounting plate. The cabinet 119 may serve to shield and contain the electronic components from the liquid reagents. The cabinet 119 may also contain user accessible controls and status indicators.

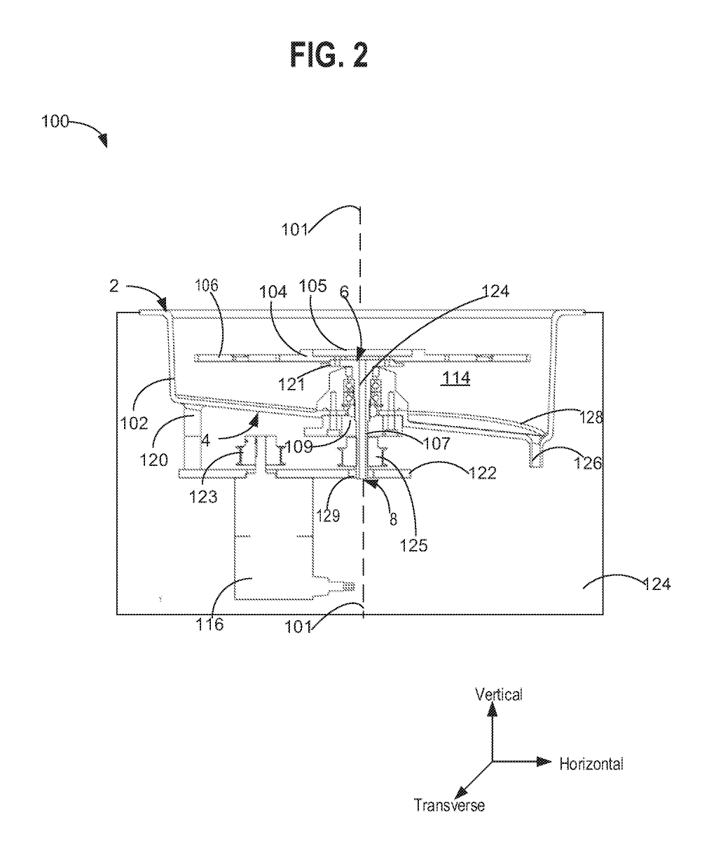

The catch basin 102 may include an inner wall 114 and a catch basin floor 128. The catch basin floor 128 may be sloped in relation to the horizontal axis of the slide stainer 100. In one example, the incline of the catch basin floor 128 may be towards a drain connection 126 on the catch basin floor 128, as illustrated in FIG. 2. The sloping of the catch basin floor 128 towards the drain connection 126 may function to direct the flow of the reagents collected in the catch basin 102 towards the drain connection 126. In one example, the drain connection 126 may be located at the periphery of the catch basin 102. In another example, the drain connection 126 may be towards the center of the catch basin 102. In other examples, a plurality of drain connections may be present on the catch basin floor 128.

The catch basin 102 may house the rotary carousel 104, as illustrated in FIGS. 1 and 2. In one embodiment, the rotary carousel 104 may include a rotary carousel hub 105, a rotary carousel shaft 124 and the plurality of slide trays 106 attached to the rotary carousel hub 105. The rotary carousel shaft 124 may be oriented along the center axis 101 of the automated slide stainer 100. The rotary carousel shaft 124 may include rotary carousel shaft first end 6 and a rotary carousel shaft second end 8, opposite the rotary carousel shaft first end 6. The rotary carousel shaft first end 6 may be positioned inside the catch basin 102 while the rotary carousel shaft second end 8 may be outside the catch basin 102, vertically downwards towards the mount plate 122. In one example, the rotary carousel shaft first end 6 may extend mid-way between the catch basin floor 128 and the catch basin top end 2. In another example, the rotary carousel shaft first end 6 may extend one third of the depth of the catch basin 102. The rotary carousel shaft first end 6 may include a shaft stage 121. The shaft stage may be at least partly in face-sharing contact with the rotary carousel hub 104 and may function as an anchoring and rotating mechanism of the rotary carousel 104. In one example, the rotary carousel hub 105 may be secured to the top of the shaft stage 121 by a plurality of positioning screws. In another example, the hub may be welded to the shaft stage 121.

The rotary carousel shaft 124 may insert into and pass through a complementary opening 107 on the catch basin floor 128. In one embodiment, the complementary opening 107 may be located at the center of the catch basin floor 128. The rotary carousel shaft 124 inserting into the opening 107 may be in apposition with a support structure 109. In one example, the support structure 109 may function to stabilize the rotary carousel and may prevent rotary carousel 104 from wobbling during rotation of the rotary carousel shaft 124. In another example, the support structure 109 may include a bearing system, aiding in rotation of the rotary carousel along the center axis 101. In other examples, the support structure 109 may include one or more gaskets in face sharing contact with the insertion hole 107. In one example, the gaskets may form a liquid-tight seal between the complementary hole and the inserting rotary carousel shaft 124, while enabling rotational movement of the rotary carousal shaft 124.

In one embodiment, the rotary carousel shaft 124 may insert into the complementary opening 107 on the catch basin floor 128, such that the rotary carousel second end 8 may insert into a complementary opening 129 on the mount plate 122, as illustrated in FIG. 2. A securing mechanism may secure the rotary carousel shaft 124 to the mount plate 122. In one example, a nut 125, as shown in FIG. 2, may secure the rotary shaft 124 to the shaft stage 121. The nut 125 may include a bearing system (for example, a ball-bearing system, a roller-bearing system) in contact with the carousel shaft 124, enabling rotation of the carousel shaft 124.

The rotary carousel shaft 124 connecting to the mount plate 122 may be coupled to a motor 116, as illustrated in FIGS. 1 and 2. The motor 116 may be an electric motor, enabling precise positioning of the rotary carousal 104 and the slide trays 106. The motor 116 may also vary the rotational speed of the rotary carousel 104. The motor 116 may rotate the rotary carousel shaft 124 and the shaft stage 121. The rotary carousel hub 105 in apposition with the shaft stage 121 and the slide trays 106 radiating out of the rotary carousel hub 105 may rotate along with the carousel shaft 124. The rotation axis of the rotary carousel shaft 124 may be the center axis 101 of the automated stainer 100. A microcontroller on board the automated stainer 100 may control the speed of rotation, the direction of rotation (clockwise vs anticlockwise) and the duration of rotation of the rotary carousel 104 through the coupled motor 116.

The rotary carousel 104 may include a plurality of slide trays 106. In one embodiment, the slide trays 106 may be radially arranged on the rotary carousel hub 105, as illustrated in FIG. 1. In one embodiment, the slide trays may be reversibly attached to the rotary carousel hub 105, and may be detached from the rotary carousel hub 105. Each slide tray 106 may receive a standard microscopic slide. The microscopic slide may contain a sample on a top surface of the slide. The sample may be a biological sample. The biological sample may be of human, animal or plant origin. In a further example, the biological sample may be a tissue section. In further examples, the sample may be a blood smear, fecal material or other bodily discharge. In other examples, the biological sample may be microorganisms, such as bacteria, parasites, fungi, yeast, etc., mounted on the slide for diagnostic and/or analytical purposes.

FIG. 3 shows a top view of one slide tray 106 of the automated slide stainer 100. The slide tray 106 may include a slide tray first long side 140 and a slide tray second long side 142 opposite the first long side 140. The slide tray 106 may include a slide tray first short side 141 and a slide tray second short side 143. The slide tray first short side 141 may be in face-sharing contact with the rotary carousel hub 105, while the slide tray second short side 143, opposite the first short side 141, may be closer to the catch basin wall 114, as illustrated in FIG. 1. The slide tray first long side 140 and the slide tray second long side 142 may be parallel to each other and the slide tray first short side 141 and the slide tray second short side 143 may be parallel to each other. The slide tray first long side 140 and the slide tray second long side 142 may intersect with the slide tray first short side 141 and the slide tray second short side 143 at the edges of the slide tray 106. The slide tray 106 may receive a standard microscopic slide along a slide receiving surface 148, such that the long sides 140 and 142 and the short sides 141 and 143 of the slide tray 106 may correspond with the long and short sides of the microscopic slide, respectively. The slide tray 106 may include a slide support block on each of the long sides to support the slide within the slide tray. In one example, the slide may rest on top of the slide supports 145a and 145b on the first long side 140 and the second long side 142 of the slide tray 106, as illustrated in FIG. 3. The slide supports 145a and 145b may run along a length L2 of the slide tray 106 or may be present part of the slide tray length. The slide tray 106 may additionally or alternatively include clasps to secure the slide to the slide tray. In one example, a first clasp may secure the slide to the first long side of the slide tray and a second clasp may secure the slide to the second long side of the slide tray. The slide tray 106 may include slide-holding cutouts 144 and 146 on each of its long sides, allowing gripping of the slide along the long side of the slide, preventing touching of the slide surface with the sample during slide handling.

To prevent pooling of any liquid between the slide receiving surface 148 and the slide bottom surface, the slide tray 106 may include at least one slide tray drain opening. An embodiment in FIG. 3 shows two slide tray drain openings 110 and 112 on the side receiving surface 148. The slide tray drain openings 110 and 112 may be circular in shape. In other examples, the slide drain openings may be elliptical, rectangular, or square. The position and the number of the slide drain opening may vary amongst slide trays. In one example, the slide tray 106 may include one slide drain opening, positioned towards the first short side 141 of the slide tray, adjacent to the rotary carousel hub 105. In another example, a single slide drain opening may be present towards the slide tray second short side 143, towards the catch basin wall 114. The slide received in the slide tray may have the slide surface with the sample away from the slide drain opening while the slide surface without sample may be in face-sharing contact with the slide receiving surface 148 of the slide tray 106. The liquid draining out of the slide tray drain openings may be drained to the catch basin floor 128. The slope of the catch basin floor 128 may direct the reagent flow towards the drain connection 126.

Referring back to FIG. 1, in one example, an even number of the slide trays may be radially attached to the rotary carousel hub 105, for example 10 slide trays radially attached to the rotary carousel hub 105, as illustrated in FIG. 1. In a further example, an angle A between each of the two adjacent slide trays radiating out from the rotary carousel hub 105 may be equal for all the slide trays 106. In another example, the distribution of the slide trays along the rotary carousel may not be uniform, for example, the angle A between two adjacent slides may vary between the slide trays. The slide trays 106 radiating out of the rotary carousel hub 105 may extend towards the catch basin inner wall 114, such that the slide receiving surface 148 along the length of the slide tray may be facing the catch basin top end 2. In one example, a first slide tray of the rotary carousel 104 may not be in face sharing contact with any other slide tray of the rotary carousel. In another embodiment, the slide trays may not be in face sharing contact with the catch basin inner wall 114. The distance of the slide tray second short side 143 from the catch basin inner wall 114 may be same for all slide trays 106. In another example, the distance of the slide trays form the catch basin bottom end 4 may be same for all slide trays. In other examples, the distance of the slide tray from the catch basin floor 128 may be varied, as illustrated in FIG. 5.

Referring to FIG. 5, in one example, the slide trays 106 coupled to the rotary carousel 104 may be tilted relative to the center axis 101. The angle of the slide tray 106 relative to the center axis 101 may be changed using a tilting mechanism, controlling the inclination of the slide tray receiving surface 148, as illustrated in FIG. 5. The inclined slide tray may function to drain off reagent from the surface of the slide positioned on the slide tray along the inclined surface, towards the catch basin floor 128. The reagent collected in the catch basin floor 128 may be directed to the drain connection 126 of the catch basin 102. In one example, the slide tray 106 may be inclined, such that the second short side 143 of the slide tray 106 may be closer to the catch basin floor 128, compared to the first short side 141. In one example, inclining the slide tray 106 may result in the first short side 141 of the slide stainer to be in one plane and the second short side 143 of the slide tray to be in a second lower plane of the catch basin 102. In a further example, a tilting mechanism may move the slide tray first long side 140 to a lower plane and the slide tray second long side 142 to a higher plane, tilting the slide along its long side, while the slide tray first short side 141 may be in the same plane as the slide tray second short side 142. In another example, amongst a plurality of slide trays, a first slide tray may be at one angle while a second slide tray may be at another angle, relative to the rotary carousel shaft 124.

A tilting mechanism of the slide tray may include a tilting system 150 at the interface of the slide tray 106 and the rotary carousel hub 105, an actuator, and a securing mechanism to hold the tilted slide tray position. A microcontroller on board may control the tilting mechanism. In one example, the tilting system 150 may be movable lever, a first end of the lever fixed to the rotary hub 105 and a second end of the lever fixed to the slide tray 106. The lever may move relative to fixed fulcrum. The lever first end may be fixed to the rotary carousel hub 105 and may act as fulcrum while the lever second end may be attached to the slide tray 106 and may move relative to the lever first end, changing the angle of the slide tray relative to the center axis 101. The lever may be secured at a specific position/angle by an interlocking mechanism. The interlocking mechanism may include complementary face sharing interlocking grooves and protrusions on the lever and the adjacent components of the rotary carousel and the slide tray. In another example, the tilting mechanism may include an extension arm of the slide tray attaching to the rotary carousal hub, such that the extension arm may be moved radially, changing the angle of the slide tray relative to the center axis 101. In further examples, a tilt mechanism may include a bearing system for smoother tilting movement.

A plurality of dispensing nozzles 108 may be housed inside the catch basin 102, as shown in FIG. 1. The dispensing nozzle 108 may function to discharge a stream of liquid reagent that may be directed towards the slide receiving surface 148 of the slide trays 106 of the rotary carousel 104. In one example, the dispensing nozzles 108 may be positioned on the catch basin inner wall 114. In other example, the dispensing nozzle may be positioned in a center area of the catch basin 102, dispensing a reagent stream radially outward. In a further example, some dispensing nozzles may be positioned on the inner wall 114 of the catch basin while additional dispensing nozzles may be placed toward the center of the catch basin. In another example, one dispensing nozzle may be present in the automated stainer 100.

In another embodiment, as illustrated in FIG. 10, a plurality of dispensing nozzles 108 may be positioned on the hinged removable lid 103 covering the catch basin, the dispensing nozzles directed down towards the slide trays 106. In one example, the dispensing nozzles 108 on the lid may be present in addition to dispensing nozzles inside the catch basin 104.

FIG. 4 illustrates a dispensing nozzle 108 positioned on the inner wall 114 of the catch basin 102. The dispensing nozzle 108 may include a nozzle end 130, and an insertion end 134 opposite the nozzle end 130. The insertion end 134 may insert into a corresponding insertion hole, for example the insertion hole 133 on the catch basin inner wall 114, as illustrated in FIG. 4. The dispensing nozzle 108 may insert into the insertion hole 133, such that the inserting end 134 of the dispensing nozzle 108 may extend across the wall of the inner wall 114 to the outer surface of the catch basin 102. In other example, the insertion end may not extend from the inner wall to the outer wall of the catch basin 102. A projection 136 on the dispensing nozzle may be in face sharing contact with the inner wall 114. The position of the projection 136 along the length of the dispensing nozzle may define the length of the dispensing nozzle passing through the inserting hole 133. In one example, a length L1 of the dispensing nozzle 108 may extend from the projection 136 to the nozzle end 130 of the dispensing nozzle 108. In one example, the inserting end 134 of the dispensing nozzle may be secured to the catch basin 102 by welding the inserting end 134 to the wall of the catch basin 102. In a further example, the dispensing nozzle 108 may be movable relative to the inserting end 134. In another embodiment, the dispensing nozzle insertion end 134 may have a tilt mechanism or rotation mechanism to vary the position of the dispensing nozzle end 130 relative to the slide surface. In one embodiment, the dispensing nozzle 108 may be parallel to the slide tray 106 of the rotary carousel 104, as illustrated in FIG. 5.

The slide tray 106, with the length of L2 may be positioned partly under the dispensing nozzle 108, at a vertical distance D1 between the dispensing nozzle and the slide tray. The distance D1 may be determined by the position of the dispensing nozzle mounting on the catch basin 102 and the length of rotary carousel shaft first end 6 extending inside the catch basin 102 with the radiating slide trays 106. In one example, the dispensing nozzle and the slide tray may overlap such that the dispensing nozzle spray end 130 may extend to overlap with 40% of the slide tray length L2, without any face-sharing contact between the dispensing nozzle 108 and the slide tray 106. The distance D1 through the overlap may remain fixed or may change, for example, tilting the slide tray 106 towards the catch basin floor 128 may increase the distance D1 between the slide tray and the nozzle, as illustrated in FIG. 5. In one example, the distance D1 separating the dispensing nozzle 108 and the slide tray 106 may increase along slope of the slide. In another example, the distance D1 may also be varied by tilting the dispensing nozzle.

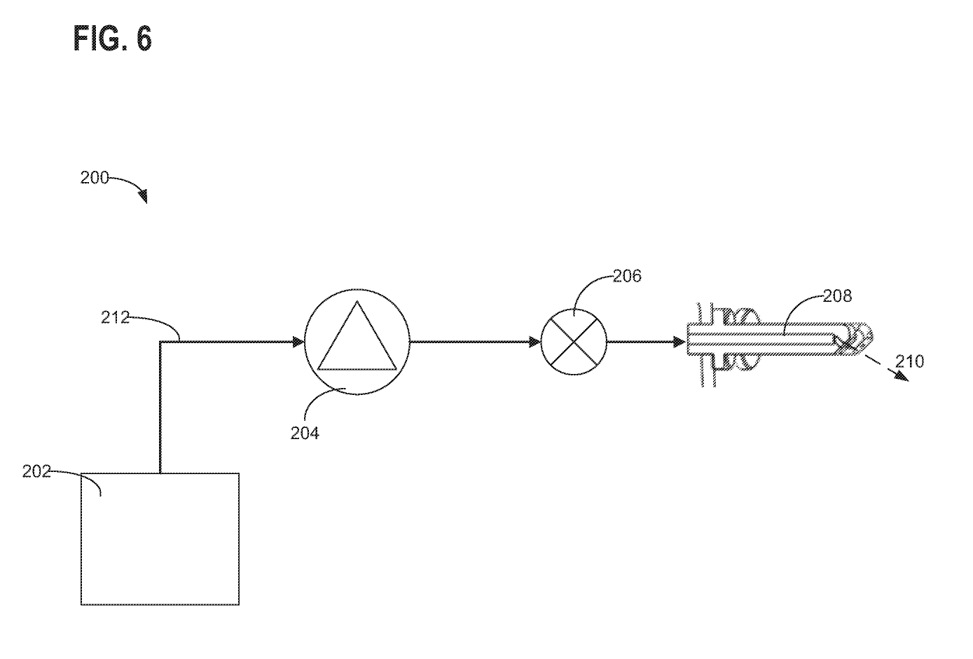

A hollow dispensing passage 132 may be present inside the dispensing nozzle 108. The dispensing passage may function to flow a liquid reagent across the dispensing nozzle and dispense it through a hole at the nozzle end 130. In one example, more than one nozzle hole may be present at the nozzle end 130. The arrangement of the nozzle holes may determine the stream pattern of the liquid reagent being dispensed by the dispensing nozzle. The diameter of the dispensing passage may determine the volume of fluid that may pass through the dispensing nozzle 108. The dispensing passage 132 of the dispensing nozzle 108 may connect to a reagent reservoir system, as illustrated in FIG. 6. In an example, the liquid reagent dispensed form the dispensing nozzle may contact the slide surface with the sample in a center area of the slide. In one example, the reagent may be discharged at an angle of 60 degrees relative to the slide surface. In other example, the angle of stream discharge may be 75 degrees relative to the slide surface.

Amongst a plurality of dispensing nozzles 108, in one example, a first dispensing nozzle may dispense one liquid reagent, different from a second dispensing nozzle dispensing a second liquid reagent. In one example, the plurality of dispensing nozzles may all dispense a first liquid reagent at the same time. In another example, each of the dispensing nozzle may dispense different reagents at different times. In one example, one dispensing nozzle may dispense a reagent at a given time. The volume of reagent dispensed by each dispensing nozzle may be same. In other examples, the volume of reagent dispensed by each dispensing nozzle may be different from the volume of reagent dispensed by the other dispensing nozzles. In a further examples, the plurality of dispensing nozzles may be spaced equally from the adjacent dispensing nozzle, or may be spaced unequally

Referring to FIG. 6, a reagent reservoir and delivery system 200 coupled to a dispensing nozzle 208 is illustrated. In one non-limiting example, the reagent reservoir and delivery system 200 may include a dispensing nozzle 208 coupled to a reagent flow tubing 212, with the reagent flowing in the direction of the arrows. The reagent flow tubing 212 may be connected to a liquid reagent reservoir 202. A pump 204 may pump a reagent from the reagent reservoir 202, through the reagent tubing 212, towards the dispensing nozzle 208. The liquid reagent may be discharged from the dispensing nozzle 208 along a stream pathway 210. The pump 204 may regulate the flow rate of the stream of reagent. The pump may be an electromechanical positive displacement fluid pump, for example a diaphragm pump or a peristaltic pump. A valve 206 may regulate the reagent flow to the dispensing nozzle 208. The valve 206 may allow flow of the liquid reagent in one direction, from the reservoir to the dispensing nozzle. The valve 206 may also ensure a smooth flow of the liquid reagent from the dispensing nozzle, buffering the impulses originating from the pump. The valve 206 may be a fluid flow control valve with an actuator, for example, a globe valve, a diaphragm valve, or a butterfly valve. In one example, more than one valve may be present along the reagent tubing 212 of the reagent reservoir system 200. The pump 204 and the valve 206 may be coupled to a microcontroller, regulating the duration and the power of pump operation and regulating the position of the valve 206 through an actuator. In one example, each of the plurality of the dispensing nozzles of an automated stainer may connect to a separate reagent and reservoir system. In another example, one reagent reservoir may be connected to more than one dispensing nozzle of an automated slide stainer.

The type and volume of reagents stored inside the reagent reservoir system may depend on the staining procedure for which the automated slide stainer is used. For example, histological staining of a biological sample may include a histological stain in one reagent reservoir, a counter-stain in a second reagent reservoir and a wash buffer in a third reagent reservoir. A decolorization regent may also be used for histological staining protocols. In other example, the reagents may include a first antibody solution in one reservoir and a second antibody solution in a second reservoir system for immunostaining protocols. In other examples, reagents may include labelled nucleic acid probes.

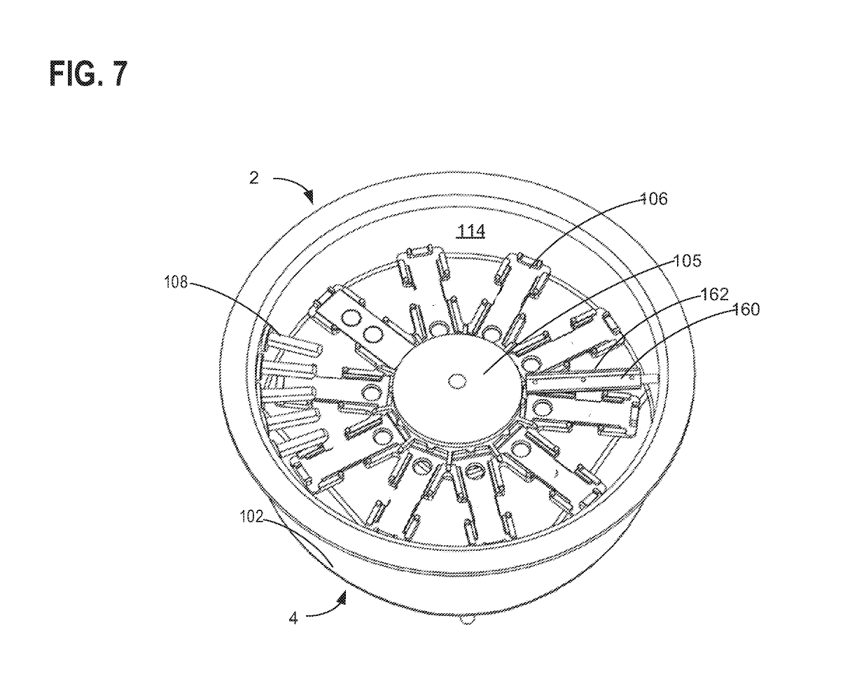

An embodiment of a slide stainer with a laminar airflow system is illustrated in FIGS. 7-9. A laminar airflow tube 160 may be housed inside the catch basin 102, also housing the rotary carousel 104 with the slide trays 106, and the dispensing nozzles 108. The laminar flow tube 160 may include a narrow air discharge opening 162 along the length of the tube. The laminar flow tube air discharge opening 162 may direct a stream of air at the slide trays 106 to remove any residual reagents from the surface of the slide mounted on the slide tray 106 and to air-dry the slides. In one example, the laminar airflow tube 160 may be fixed to the inner wall 114, such that the laminar airflow tube 160 may be in a vertically upward plane relative to the slide trays 106. In one example, the laminar airflow tube 160 may be parallel to the slide trays 106 but with no face-sharing contact with the slide trays. In another example, the laminar airflow tube 160 may be fixed at the center of the catch basin 102.

In one embodiment, more than one laminar airflow tube may be housed inside the catch basin 102. In an example, the angle of the laminar airflow tube 160 may be changed in relation to the slide surface. In one example, the rotary carousel may sequentially index each of the slide trays 106 to precisely position the slide trays to receive an air stream 164 from the laminar airflow tube 160, as illustrated in FIG. 8. The laminar flow tube may discharge a stream of air to a slide tray with a slide as the slide tray positions under the laminar flow tube. In one example, more than one slide tray may receive the air stream from the laminar airflow tube 160 at one given time. The laminar airflow tube 160 may receive air supply from a connected laminar airflow system.

FIG. 9 illustrates the laminar airflow system 300, including a laminar flow tube 350 with a laminar tube opening 352. The laminar flow tube may receive compressed airflow through an airflow tubing 310 coupled to a compressed air reservoir 304. A pump 302 downstream of the compressed air reservoir 304 may pump the compressed air from the air reservoir 304 through the airflow tubing 310 towards the laminar airflow tube 350. A flow control valve 306 may regulate the airflow to the laminar flow tube 350. The valve 306 may be coupled to an actuator. A filter 308 may be positioned along the airflow tubing 310, before the air enters the laminar airflow tube 350, preventing any unwanted material from entering the automated stainer air stream. In one example, the filter 308 may trap microorganisms such a bacteria, bacterial spores, fungal spores, etc. In another example, more than one air filter trap may be positioned along the airflow tubing 310. A micro controller may regulate the volume, the duration, and the force of the air discharge from the laminar airflow tube 350.

An example method 500 using the automated slide stainer 100 to stain slides is shown in FIG. 11. The slides may include a top surface with a sample, for example a biological sample. The staining procedure may be to stain histological, immunohistochemical or cellular components of the biological sample on the slide surface. The staining protocol may include dispensing one or more reagents on the slide surface. The duration of the slide with the reagent on its top surface may vary depending on the sample and the protocol for staining the sample. A microcontroller may control the volume of a reagent dispensed through a dispensing nozzle to the slide surface. The reagents dispensed on the slide surface may need to be removed from the slide surface. In some examples, a wash reagent may be dispensed from the dispensing nozzle to the slide surface to wash away residues of a first reagent before adding a second reagent.

The method 500 starts with the automated slide stainer receiving a microscopic slide with a sample, in a horizontal orientation on a slide tray of a rotary carousel. Each slide tray may be configured to receive one microscopic slide. A securing mechanism may position or secure the slide within the slide tray, for example, the slide supports 145a and 145b on the automated slide stainer 100. In one example, all the slide trays of the rotary carousel may receive a microscopic slide with a biological sample, for example, ten slide trays may each receive a slide with a sample. In other examples, a few of the slide trays may each receive a microscopic slide while the others may not. The slide surface with the sample may face away from the slide-receiving surface of the slide tray, for example the slide-receiving surface 148 of the slide tray 106, illustrated in FIG. 3. The method 500 may proceed to 504, where the rotary carousel may precisely position the slide tray with the slide in proximity of a dispensing nozzle in a treatment position. In one example, positioning the slide tray in the treatment position may be done by a positioning device coupled to the rotary carousel. In one example, the positioning device may be a mechanical device. In another example, an electric motor controlled through a microcontroller may be the positioning device for rotary carousel. In another example, two slide trays may be positioned to receive liquid reagent from one dispensing nozzle. In a further example, a slide tray may be positioned to receive liquid reagent from more than one dispensing nozzle.

After positioning of the slide trays in proximity of the dispensing nozzle in the treatment position, the method 500 proceeds to 506, where the dispensing nozzle may dispense a stream of a liquid reagent to the top surface of the slide on a slide tray positioned in treatment position. The volume of reagent delivered by the dispensing nozzle may uniformly cover/soak the top surface of the slide with the biological sample. The duration of the liquid reagent remaining on the top surface of the slide may be specific to the staining protocol and may depend on the type of sample being stained. The rotary carousel may remain stationary during incubation of the slide with dispensed reagent.

At the end of the staining period, the method 500 may proceed to 508, where the reagent discharged on top of the slide surface may be removed from the slide surface. A microcontroller may control the removing of the reagent from the slide surface. In one example 510, reagent removal from the slide surface may be by spinning the rotary carousel at a specified speed/RPM for a fixed duration of time, for example 1000 RPM for 1 minute. The centrifugal force generated by the spinning rotary carousel and the attached slide trays may remove the reagent discharge from the slide surface. The speed of rotation and the duration of rotation of the rotary carousel may be controlled by the microcontroller.

In another example 512, the reagent may be removed by inclining the slide tray, such that a short edge of the slide tray may slope towards the catch basin floor, lower than the other short edge of the slide, as illustrated in FIG. 5. The reagent from the slide mounted on the slide tray may drain off towards the catch basin floor. In one example, all the slide trays may be inclined at one given time by the microcontroller. In another example, tilting of each individual slide tray may be independent from the other slide trays. The duration of the tilting may depend on the staining procedure and the sample and may be regulated by the micro controller. The angle of the tilting slide tray may determine of the slope of the slide surface.

In another example 514, the reagent discharge may be removed from the slide surface by a laminar airflow system, for example the laminar airflow system 300 illustrated in FIG. 9. The laminar airflow tube may discharge a sheet of pressurized air from a compressed air reservoir to remove reagent from the slide surface. The force of the air discharge may be defined by the discharge opening on the laminar flow tube and may be regulated by the microcontroller.

For removing the liquid reagent discharge from the slide surface, a combination of reagent removing mechanisms may be used. For example, air may be discharged from the laminar flow to the slide trays while the rotary carousal is rotating, such that a combination of centrifugal force and laminar airflow directed at the slide surface may remove the reagent from the slide surface. In another example, the slide trays may be tilted and the tilted slides may be rotated by the rotary carousel to remove reagent from the slide surface. In a further example, airflow may be directed to the tilted slides to remove reagent from the slide surface. The staining protocol may include multiple cycles of reagent dispensing and reagent removal, each cycle including the same reagent or a different reagent. In some examples, the reagent may be a wash reagent to remove unwanted residue of a previous reagent. The duration of the reagent dispensing and reagent removing cycles may vary according to the staining protocol.

Thus, an automated slide stainer with a plurality of slides in a horizontal orientation can stain the sample on the slides by directing a controlled stream of liquid reagent on the slide surface with the sample, uniformly covering the slide surface, without any cross-contamination between the plurality of slides on the rotary carousel. The slide may be incubated with the reagent on the slide surface for a specified amount of time, at the end of which the automated slide stainer may remove the reagent discharge from the slide surface, thereby making the automated stainer conducive for various staining protocols.

It is understood that the automated slide stainer described and illustrated herein represents only an example embodiment. It is appreciated by those skilled in the art that various changes and additions may be made to such an automated slide stainer without departing from the spirit and scope of this invention.

In one embodiment, an automated slide stainer may include a rotary carousel with a plurality of slide trays, each slide tray configured to receive a microscopic slide in a horizontal orientation, a positioning device to move each slide tray to a treatment position and a dispensing nozzle to dispense a liquid reagent on the microscopic slide when in treatment position. The automated slide stainer may further include a motor as the positioning device, sequentially positioning each slide tray of the rotary carousel in the treatment position. In one example, the dispensing nozzle may be connected to a reagent reservoir system with a pump and a valve, regulating the discharge of the reagent from the dispensing nozzle.

In one example, an automated slide stainer with a rotary carousel with a plurality of slide trays may include at least one slide drain opening in each of the slide trays. The rotary carousel of the automated slide stainer may include a slide securing mechanism on each of the slide trays. The rotary carousel may further include cutouts on each of the slide trays for gripping the slides without touching the slide top and bottom surfaces. In another example, each of the slide trays may include a tilting mechanism.

In one embodiment, a rotary carousal with a plurality of slide trays and at least one dispensing nozzle may be housed inside a catch basin. The catch basin may also include a laminar airflow tube for discharging air-stream directed at the slide trays. The catch basin may include at least one drain connection.

An example method for staining a slide using an automated slide stainer, may include receiving a microscopic slide in a rotary carousel in a horizontal orientation, positioning the microscopic slide in a treatment position for receiving a liquid reagent, dispensing the liquid reagent to the slide surface through a dispensing nozzle, and removing of the liquid reagent discharge from the slide surface. The method may further include positioning of the microscopic slide on the rotary carousel in the treatment position by a motor coupled to the rotary carousel. The method may include dispensing the liquid reagent from the dispensing nozzle coupled to a reagent reservoir, regulating reagent flow through a valve and a pump. The method may include removing the liquid reagent discharge from the slide surface by rotation of the rotary carousel. In another example, removing the reagent discharge may include inclining the slide tray with the slide. In a further example, reagent removing from the slide surface may include blowing compressed air through a laminar airflow system.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. An automated slide stainer, comprising:
a rotary carousel including a plurality of slide trays, each slide tray configured to receive a microscopic slide in a horizontal orientation;
a positioning device to move each slide tray to a treatment position; and
a dispensing nozzle to dispense a liquid reagent on the microscopic slide in treatment position.

2. The automated slide stainer of claim 1, wherein the positioning device is a motor coupled to the rotary carousel, sequentially positioning each slide tray of the rotary carousel in the treatment position.

3. The automated slide stainer of claim 1, wherein the rotary carousel includes at least one slide drain opening in each of the slide trays.

4. The automated slide stainer of claim 1, wherein the rotary carousel includes a slide support mechanism on each of the slide trays.

5. The automated slide stainer of claim 1, wherein the rotary carousel includes cutouts on each of the slide trays for gripping the slides without touching the slide top and bottom surfaces.

6. The automated slide stainer of claim 1, wherein each of the slide trays of the rotary carousel includes a tilting mechanism.

7. The automated slide stainer of claim 1, wherein the dispensing nozzle is connected to a reagent reservoir system.

8. The automated slide stainer of claim 7, further comprising a valve regulating reagent flow through the dispensing nozzle connected to the reagent reservoir system.

9. The automated slide stainer of claim 7, further comprising a pump regulating reagent flow through the dispensing nozzle connected to the reagent reservoir system.

10. The automated slide stainer of claim 1, further comprising a compressed air laminar airflow system to discharge a stream of air on the microscopic slides.

11. The automated slide stainer of claim 1, wherein the dispensing nozzle includes a tilting mechanism.

12. A method for staining slide using an automated slide stainer, comprising:
receiving a microscopic slide in a rotary carousel in a horizontal orientation;
positioning the microscopic slide in a treatment position for receiving a liquid reagent;
dispensing the liquid reagent to the slide surface in the treatment position through a dispensing nozzle; and
removing the liquid reagent discharge from the slide surface.

13. The method of claim 12, wherein positioning of the microscopic slide on the rotary carousel is done by a motor coupled to the rotary carousel.

14. The method of claim 12, wherein the dispensing nozzle dispenses the liquid reagent from a connected reagent reservoir, regulating reagent flow through a valve and a pump.

15. The method of claim 12, wherein removing the liquid reagent discharge from the slide surface is by rotation of the rotary carousel.

16. The method of claim 12, wherein removing the liquid reagent discharge from the slide surface is by inclining the slide tray of the rotary carousel.

17. The method of claim 12, wherein removing the liquid reagent discharge is from the slide surface is by blowing compressed air through a laminar airflow system.

18. An automated slide stainer, comprising:
a rotary carousel including a plurality of slide trays, each slide tray configured to receive a microscopic slide in a horizontal orientation;
a positioning device to sequentially position each slide tray to a treatment position;
at least one dispensing nozzle to dispense a liquid reagent on the microscopic slide when in treatment position; and
a catch basin, housing the rotary carousel and the dispensing nozzle.

19. The automated slide stainer of claim 18, wherein the catch basin includes at least one drain connection.

20. The automated slide stainer of claim 18, wherein the dispensing nozzle is attached to an inner wall of the catch basin.
